(19) United States
(12) Patent Application Publication
(10) Pub. No.: US 2026/0103019 A1
(43) Pub. Date: Apr. 16, 2026

(54) CARBON FIBER SPOKE ANTI-LOOSENING STRUCTURAL IMPROVEMENT

(71) Applicant: CHUN NAN JIN-JI TECHNICAL CO., LTD., New Taipei (TW)

(72) Inventor: HUNG-CHANG CHU, New Taipei (TW)

(21) Appl. No.: 18/917,984

(22) Filed: Oct. 16, 2024

(51) Int. Cl. B60B 5/02

(52) U.S. Cl. CPC B60B 5/02; B60B 2310/318

(57) ABSTRACT

A carbon fiber spoke anti-loosening structural improvement comprises a cap head element and a carbon fiber spoke. A sleeve part of the carbon fiber spoke is inserted from a guide channel of the cap head element into an accommodating space of the cap head element, and then the carbon fiber spoke is rotated to correspond two corresponding inclined parts of the carbon fiber spoke onto two resisting parts of the cap head element. Since the two inclined parts of the carbon fiber spoke are restricted and resisted by the two resisting parts, the sleeve part of the carbon fiber spoke is placed in the accommodating space of the cap head element and is fixed without being detached, thereby preventing the cap head element and the carbon fiber spoke from loosening.

### BACKGROUND OF THE INVENTION

### Field of the Invention

The invention relates to a carbon fiber spoke anti-loosening structural improvement, more particularly to a spoke structure capable of preventing loosening and strengthening stability.

### Related Art

The sport of riding bicycles has become more and more popular in recent years, and therefore many manufacturers have continued to invest in the research and development and production of bicycles. However, in order to achieve an object of reducing weight and realizing lightweight, the spokes are made of carbon fiber material; due to the difficulty in processing carbon fiber material, other components need to be sleeved on the two ends of the carbon fiber spoke. However, due to the strong rigidity of the carbon fiber spoke, it is not easy to embed the sleeve components into the carbon fiber spoke. During the embedding process, it is easy to cause the two ends of the carbon fiber spoke to be brittle in unspecified directions or positions, which not only affects the product yield, but also leads to subsequent safety hazards. Therefore, it can be known that the combination between carbon fiber spoke and sleeve components is easily detached or unstable. Therefore, how to improve the drawbacks and tackle the problems mentioned above is the technical difficulty that the inventor of the invention wants to solve.

### SUMMARY OF THE INVENTION

A main object of the invention is to provide a carbon fiber spoke anti-loosening structural improvement composed of a cap head element and a carbon fiber spoke. A sleeve part of the carbon fiber spoke is inserted from a guide channel of the cap head element into an accommodating space of the cap head element, and then the carbon fiber spoke is rotated to correspond two corresponding inclined parts of the carbon fiber spoke onto two resisting parts of the cap head element. Since the two inclined parts of the carbon fiber spoke are restricted and resisted by the two resisting parts, the sleeve part of the carbon fiber spoke is placed in the accommodating space of the cap head element and is fixed without being detached, thereby preventing the cap head element and the carbon fiber spoke from loosening.

In order to achieve the above object, wherein a width of the guide channel is smaller than a width of the accommodating space.

In order to achieve the above object, wherein when the sleeve part of the carbon fiber spoke is embedded in the accommodating space of the cap head element, the two inclined parts of the carbon fiber spoke correspond to the two resisting parts of the cap head element.

In order to achieve the above object, wherein the sleeve part of the carbon fiber spoke is in an elliptical shape, so that the sleeve part has a narrow side and a wide side.

In order to achieve the above object, wherein an adhesive layer is provided on a surface of the sleeve part of the carbon fiber spoke.

### BRIEF DESCRIPTION OF THE DRAWINGS

FIG. 1 is a perspective view of the invention.

FIG. 2 is an exploded perspective view of the invention.

FIG. 3 is a cross-sectional view of the invention.

FIG. 4 is a first schematic diagram of a preferred embodiment of the invention.

FIG. 5 is a second schematic diagram of a preferred embodiment of the invention.

FIG. 6 is a third schematic diagram of a preferred embodiment of the invention.

FIG. 7 is a fourth schematic diagram of a preferred embodiment of the invention.

FIG. 8 is a fifth schematic diagram of a preferred embodiment of the invention.

FIG. 9 is a schematic diagram of a further embodiment of the invention.

### DETAILED DESCRIPTION OF THE INVENTION

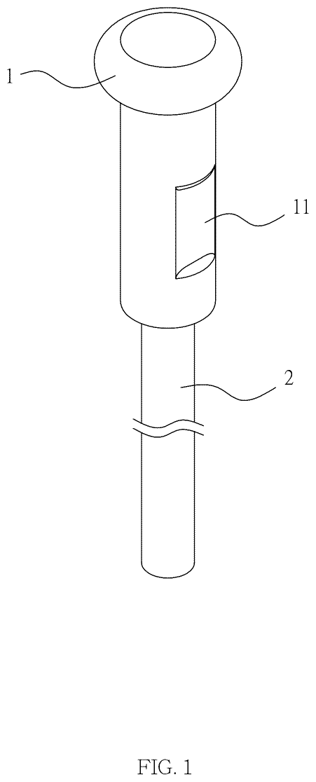

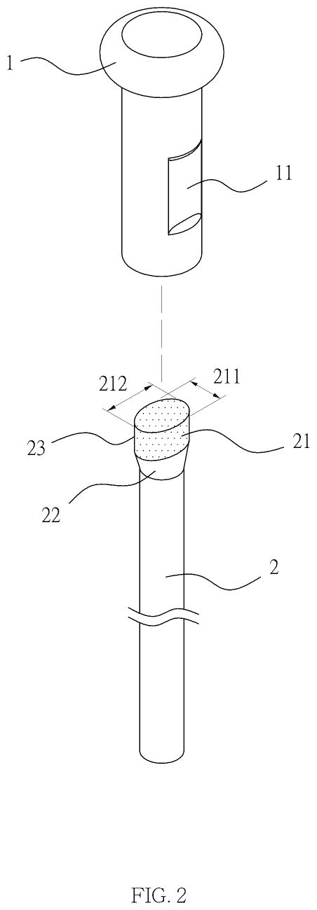

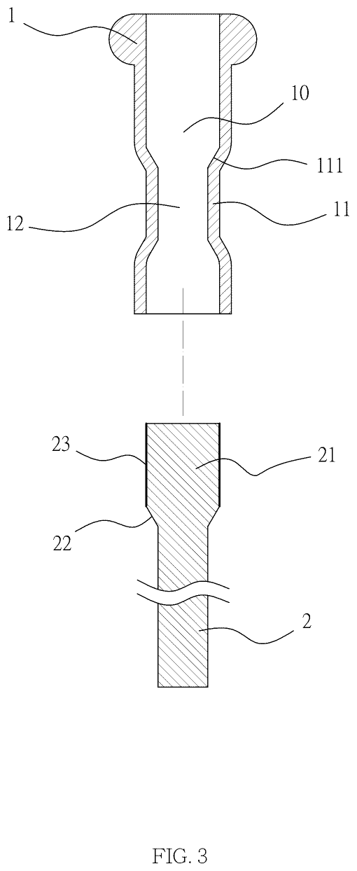

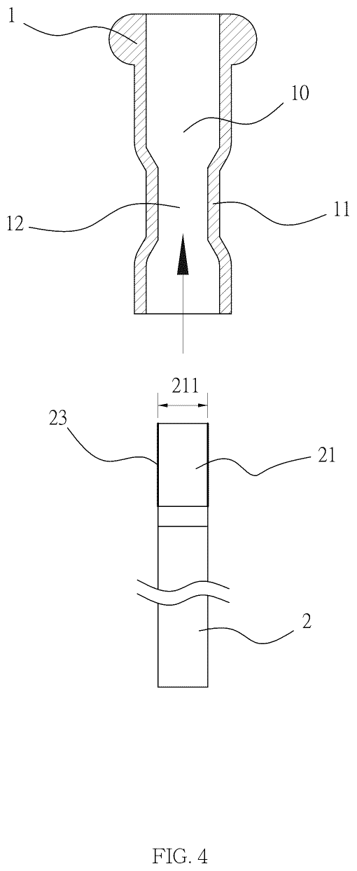

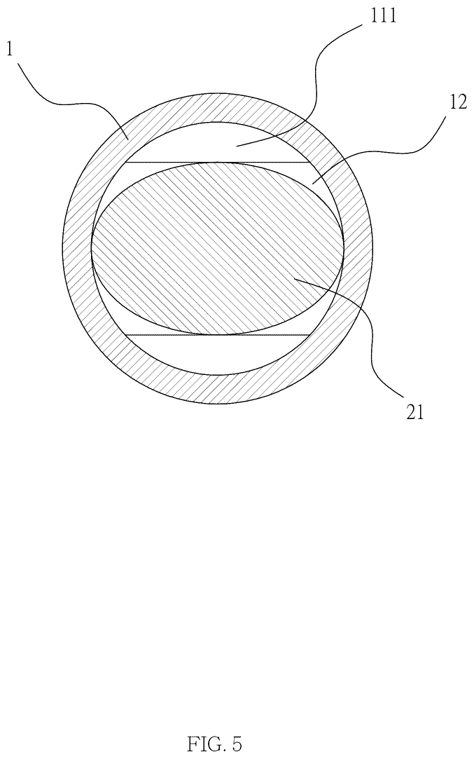

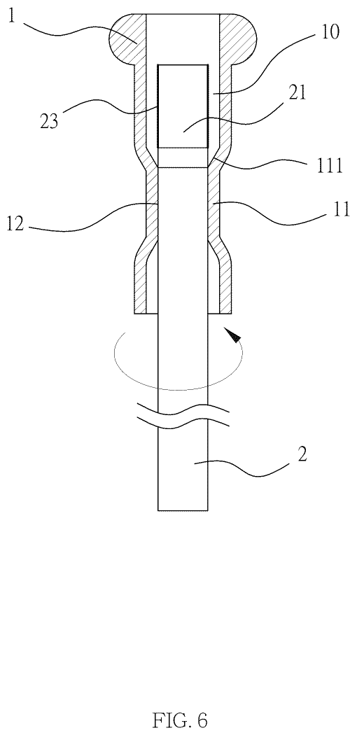

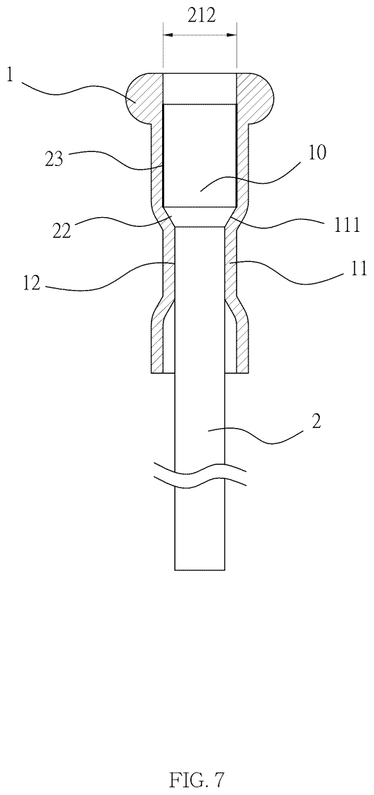

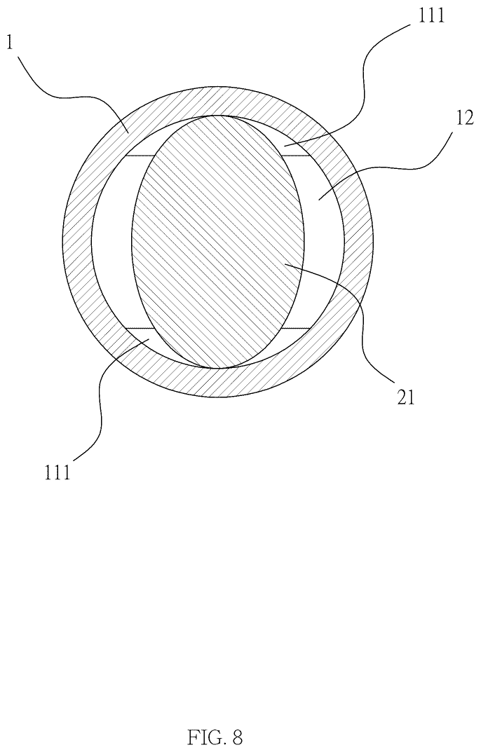

Please refer to FIGS. 1, 2, 3, 4, 5, 6, 7, 8 and 9 for a perspective view, an exploded perspective view, a cross-sectional view, schematic diagrams and a further embodiment of the invention respectively. It can be clearly seen from the figures that the invention mainly comprises the following.

A cap head element 1 has an accommodating space 10 inside and two corresponding recesses 11 are provided on an outer side thereof. The two recesses 11 form a guide channel 12 at a position corresponding to the accommodating space 10, and two corresponding resisting parts 111 are provided between the accommodating space 10 and the guide channel 12.

A carbon fiber spoke 2 is provided with a sleeve part 21 at one end thereof, and two corresponding inclined parts 22 are formed between the sleeve part 21 and the carbon fiber spoke 2. The sleeve part 21 is embedded in the accommodating space 10 of the cap head element 1.

Wherein a width of the guide channel 12 is smaller than a width of the accommodating space 10.

Wherein when the sleeve part 21 of the carbon fiber spoke 2 is embedded in the accommodating space 10 of the cap head element 1, the two inclined parts 22 of the carbon fiber spoke 2 correspond to the two resisting parts 111 of the cap head element 1.

Wherein the sleeve part 21 of the carbon fiber spoke 2 is in an elliptical shape, so that the sleeve part 21 has a narrow side 211 and a wide side 212.

Wherein a surface of the sleeve part 21 of the carbon fiber spoke 2 is provided with an adhesive layer 23.

In the invention, the sleeve part 21 of the carbon fiber spoke 2 is inserted from the guide channel 12 of the cap head element 1 into the accommodating space 10 of the cap head element 1, and then the carbon fiber spoke 2 is rotated to correspond the two inclined parts 22 of the carbon fiber spoke 2 onto the two resisting parts 111 of the cap head element 1 respectively. Since the two inclined parts 22 of the carbon fiber spoke 2 are restricted and resisted by the two resisting parts 111, the sleeve part 21 of the carbon fiber spoke 2 is restricted in the accommodating space 10 of the cap head element 1, thereby achieving an object of firmly combining the cap head element 1 and the carbon fiber spoke 2 with each other.

Based on the above, since the sleeve part 21 of the carbon fiber spoke 2 is in an elliptical shape, when the sleeve part 21 of the carbon fiber spoke 2 is inserted into the guide channel 12 of the cap head element 1, the narrow side 211 of the sleeve part 21 and the two recesses 11 of the cap head element 1 need to be perpendicular to one another to enable the sleeve part 21 to pass through the guide channel 12. After the sleeve part 21 passes through the guide channel 12 and is inserted into the accommodating space 10, the carbon fiber spoke 2 is rotated so that the wide side 212 of the sleeve part 21 and the two recesses 11 of the cap head element 1 are perpendicular to one another, thereby the two inclined parts 22 of the carbon fiber spoke 2 can be restricted and resisted by the two resisting parts 111.

In addition, an adhesive layer 23 is provided on a surface of the sleeve part 21 of the carbon fiber spoke 2, mainly to further increase a stability of combination between the cap head element 1 and the carbon fiber spoke 2 through a viscosity of the adhesive layer 23.

In the above embodiment, although the carbon fiber spoke 2 is rotated to make the two inclined parts 22 of the carbon fiber spoke 2 being restricted and resisted by the two resisting parts 111, thereby achieving an object of combination between the cap head element 1 and the carbon fiber spoke 2; if the carbon fiber spoke 2 cannot be rotated due to other limiting factors during actual processing, a same object can be achieved by rotating the cap head element 1 through performing corresponding rotational movements when the carbon fiber spoke 2 or the cap head element 1 is in a fixed position, and its structural characteristics are not changed.

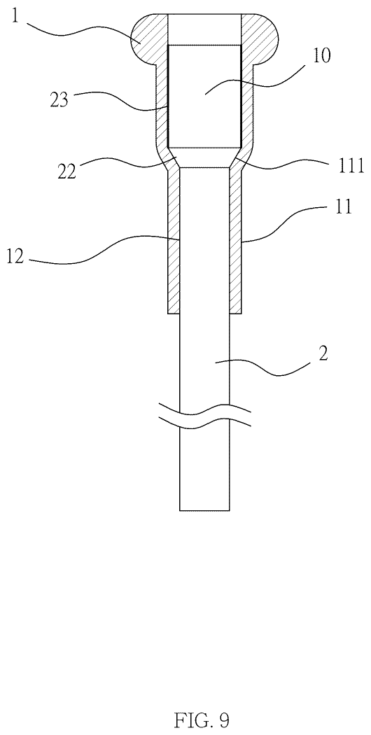

In addition, as shown in FIG. 9, which is a further embodiment of the invention, the two recesses 11 of the cap head element 1 are mainly used as another mode. The two recesses 11 extend directly to reach a bottom of the cap head element 1, and the two recesses 11 form the guide channel 12 at a position corresponding to the accommodating space 10.

To sum up the above, compared with the conventional carbon fiber spoke fixing methods, which have various drawbacks and unsolvable problems, the invention uses special designs of the cap head element 1 and the carbon fiber spoke 2 to stably combine the cap head element 1 with the carbon fiber spoke 2. Furthermore, through the rotational fixation method, processing procedures of combination between the cap head element 1 and the carbon fiber spoke 2 can be greatly reduced.

The above-mentioned embodiments are used to illustrate one of the feasible preferred embodiments of the invention and are not intended to limit the scope of the invention. Any person having ordinary in the art can make changes and modifications without departing from the spirit and scope of the invention. Therefore, the scope of protection of the invention shall be determined by the appended claims.

What is claimed is:

1. A carbon fiber spoke anti-loosening structural improvement comprising:
a cap head element having an accommodating space inside and two corresponding recesses being provided on an outer side thereof, the two recesses forming a guide channel at a position corresponding to the accommodating space, and two corresponding resisting parts being provided between the accommodating space and the guide channel; and
a carbon fiber spoke provided with a sleeve part at one end thereof, two corresponding inclined parts being formed between the sleeve part and the carbon fiber spoke, and the sleeve part being embedded in the accommodating space of the cap head element.

2. The carbon fiber spoke anti-loosening structural improvement as claimed in claim 1, wherein a width of the guide channel is smaller than a width of the accommodating space.

3. The carbon fiber spoke anti-loosening structural improvement as claimed in claim 1, wherein when the sleeve part of the carbon fiber spoke is embedded in the accommodating space of the cap head element, the two inclined parts of the carbon fiber spoke correspond to the two resisting parts of the cap head element.

4. The carbon fiber spoke anti-loosening structural improvement as claimed in claim 1, wherein the sleeve part of the carbon fiber spoke is in an elliptical shape, so that the sleeve part has a narrow side and a wide side.

5. The carbon fiber spoke anti-loosening structural improvement as claimed in claim 1, wherein an adhesive layer is provided on a surface of the sleeve part of the carbon fiber spoke.
